(19) United States
(12) Patent Application Publication
(10) Pub. No.: US 2005/0161169 A1
(43) Pub. Date: Jul. 28, 2005

(54) Quick cornice module

(76) Inventor: Connie Webb, Bartonville, TX (US)

Correspondence Address: HammerleFinley Law Firm, Suite 300, 1660 S. Stemmons Frwy., Lewisville, TX, 75067, US

(21) Appl. No.: 11/041,179

(22) Filed: Jan. 24, 2005

Related U.S. Application Data
(60) Provisional application No. 60/538,899, filed on Jan. 24, 2004.

(51) Int. Cl. E06B 9/00

(52) U.S. Cl. 160/38

(57) ABSTRACT

A modular cornice consists of a plurality or series of panels that attach to a curtain rod, forming a modular cornice. The panels are made with a composite material that can be stained or painted. Each panel has one or more mounting brackets that allow the panel to simply clip over a curtain rod. In one embodiment, the mounting clip is secured to two adjacent panels. There are also end panels to close the gap from the wall to the front series of cornice panels. Some panels may have curved surfaces to permit joining the panels to provide an arched or circular top for use with arched windows. The face of the cornice panels may have different designs and textures. One person may install the series of cornice panels, and provide a custom fit to the width of the window area to be covered by the cornice.

### PRIORITY

Priority is claimed from Provisional Application Ser. No. 60/538,899, filed Jan. 24, 2004.

### FIELD OF THE INVENTION

The invention relates to window decorations, and more particularly to a quick mount cornice that is a series of panels that attach to a curtain rod to form a modular cornice.

### BACKGROUND OF THE INVENTION

Various cornice designs have been used to cover the curtain rod and the upper mounting area of curtains. Generally the cornice is a continuous piece of material that extends the length of the window. One problem that exists is that all windows or window groups are not the same length, and each cornice has to be custom designed and produced for that window or window groups. Listed below are examples of prior art window cornices. The examples are given by way of example only and are not intended to be cited prior art.

Design patent D454,646 shows an ornamental design for a window cornice.

U.S. Pat. No. 5,927,362 shows a window cornice assembly. The window cornice assembly may comprise a front section and two side sections upon which fabric may be arranged. Corner pieces may be mounted on the front and side sections. Fabric may be arranged and secured on the front and/or side sections by clips that retain the fabric taut and over the front face thereof. The clips can be attached to each other directly by an elastic cord or band, or attached to the rear face of the front section directly so that the fabric is tightly pulled over the front face of the front section. The elastic cord or band imparts a desired amount of elasticity to the fabric. The window cornice assembly may have one or more elongated channel-shaped support strips arranged on a front section to provide additional rigidity thereto.

U.S. Pat. No. 5,505,245 is a channeled, foam cornice window treatment. The foam cornice window treatment which is mountable on a curtain rod assembly including one or more flat, slat-like members. The foam cornice is formed of resilient foam material and includes a front non-planar surface which meets a rear, planar surface. One or more channels are formed on the rear face of the cornice for engagement with the slot(s) of the curtain rod assembly. The cornice includes a pair of rear slots formed on the rear face into which edges of a fabric covering may be tucked. Because of the resiliency of the foam body, the slots will open to receive the fabric edges, but will resiliently spring back to grip the fabric edges and hold them in place. A slot may also be formed on the front face of the cornice so that an intermediate portion of the fabric covering may be tucked thereinto to create a puffy, decorative effect.

U.S. Pat. No. 5,042,548 shows a cornice for a window covering head rail. The window covering head rail cornice has a front pane, two end plates, two corner pieces joining the end plates to the front panel, and end covers all fitted together, and unitarily secured to the head rail via clips interrelating the cornice to the front panel.

### SUMMARY OF THE INVENTION

The invention is a cornice which consists of a plurality or series of panels that attach to a curtain rod, forming a modular cornice. The panels are made with a composite material that can be stained or painted. Each panel has a series of brackets that allow the panel to simply clip over a curtain rod. There are also end panels to close the gap from the wall to the front series of cornice panels. Some panels may have curved surfaces to permit joining the panels to provide an arched or circular top for use with arched windows. The face of the cornice panels may have different designs and textures. One person may install the series of cornice panels, and provide a custom fit to the width of the window area to be covered by the cornice.

The technical advance represented by the invention as well as the objects thereof will become apparent from the following description of a preferred embodiment of the invention when considered in conjunction with the accompanying drawings, and the novel features set forth in the appended claims.

### BRIEF DESCRIPTION OF THE DRAWINGS

FIG. 1 illustrates a front view of a modular cornice of the present invention;

FIG. 2 illustrates a top view of the modular cornice;

FIG. 3 shows an isometric single cornice panel;

FIG. 4 is a front view of the cornice panel;

FIG. 5 is a side view of the cornice panel;

FIG. 6 shows another embodiment of a cornice panel;

FIG. 7 is a side view of the cornice panel;

FIG. 8 shows a device for attaching the cornice panel of FIG. 6 to a curtain rod;

FIG. 9 is a side view of the attachment device;

FIG. 10 is an isometric view of the attachment device;

FIG. 11 is a front view of a side cornice panel;

FIG. 12 is an end view of the side cornice panel;

FIG. 13 is a back view of the side cornice panel;

FIG. 14 is an isometric view of the side cornice panel;

FIG. 15 is a attaching device for securing adjacent cornice panels together; and

FIG. 16 illustrates a module cornice for use with a window with a circular top.

### DESCRIPTION OF A PREFERRED EMBODIMENT

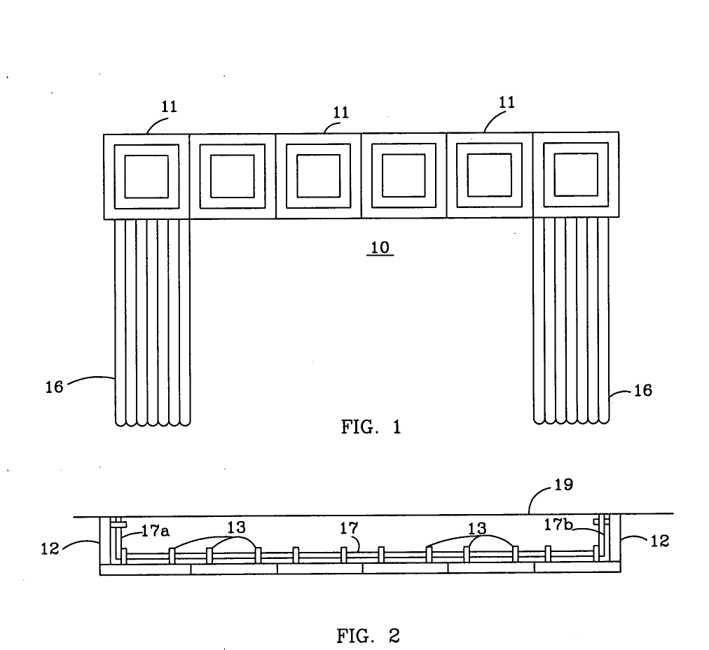

The invention is a modular cornice assembly for mounting on a curtain rod or other support at the top of a window curtain, drape, or tapestry 16 to add decor and to cover the curtain mounting hardware. FIG. 1 shows the modular cornice 10 consisting of a plurality of panels 11.

FIG. 2 is a top view showing the modular cornice attached to the curtain rod 17 which is attached to a wall 19 by curtain rod ends 17a and 17b. Each modular cornice unit has at least one mounting clip 13 attached to the modular cornice and secured to the curtain rod 17. End modular cornice units 12 attached to the curtain rod parts 17a and 17b enclose the end of the modular cornice unit 11.

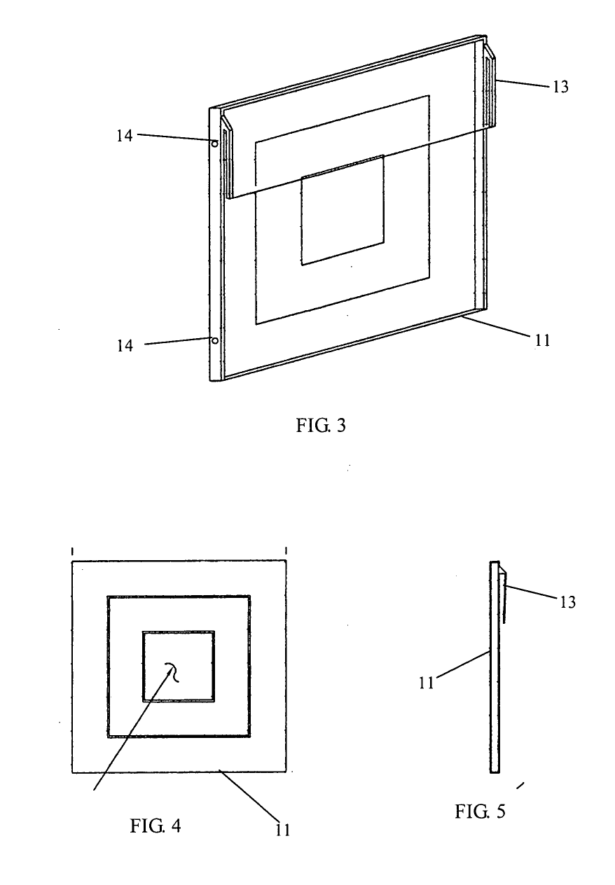

FIG. 3 shows a single modular cornice unit 11 with mounting device 13. Mounting device 13 is illustrated as a continuous piece, extend across the back of the module, but it could consist of two smaller mounting devices on each end of modular cornice 11, as illustrated in FIG. 2. There may be at least one small round hole 14 on modular cornice 11. The small holes may have a pin inserted therein to align adjacent cornice modules. For example, a pin inserted in opening 14 and extending in a similar opening in an adjacent modular panel would align the two panels and keep them from moving independently from the other.

FIG. 4 shows a front view of the modular panel 11. The design on panel 11 is shown to be a series of concentric squares, but may be of any design, either flat or raised from the surface of the panel.

FIG. 5 is a side view of panel 11 showing the clip 13 which is used to mount and secure the panel to a curtain rod, or other mounting device.

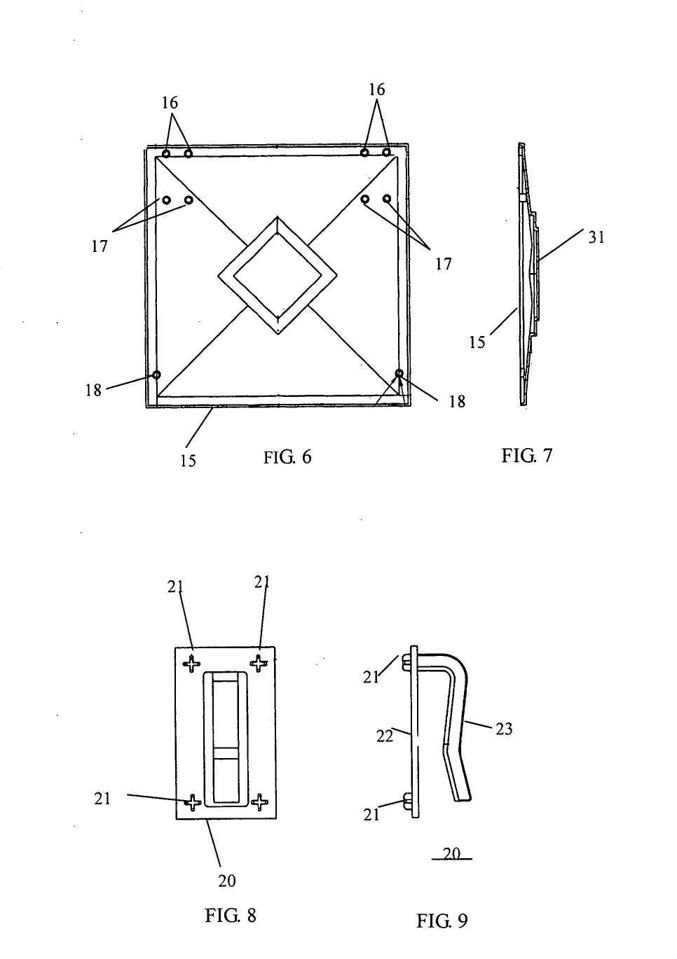

FIGS. 6 and 7 show a modular panel 15 with a raised front side 15a, and holes 16 and 17 for mounting a removable mounting clip as illustrated in FIGS. 8, 9 and 10. The Clip 20 includes a plate 22 on which a hoop 23 is attached. There are four cross-shaped tapered end pins 21 which are inserted into the holes 16 and 17 for attaching the clip 20 to the modular panel 15. Once Clip 20 is secured to the modular panel 15, it may then be attached to a curtain rod (not illustrated) for mounting the modular panel 15. The bottom ends of adjacent panels 15 may be secured together by an attachment 40 (FIG. 15) as explained below. The top ends of two adjacent modular panels may be secured together by placing two of the pins 21 of clip 20 in the outer two holes 16 and 17 (one adjacent to the edge of the panel), the other two pins 21 into the outer two holes of the adjacent panel.

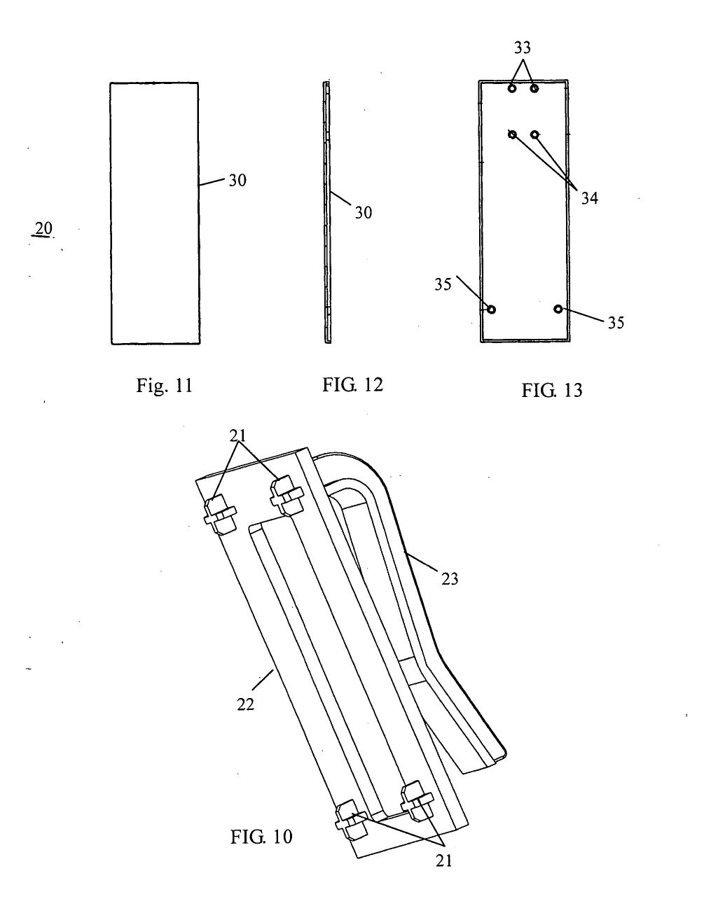

FIGS. 11-13 illustrate a small modular panel that may be used as a side panel, or placed between the larger panels to adjust the the panel length in from the window over which the cornice is mounted. Panel 30 may be made with various widths. Panel 30 has mounting holes 33 and 34 for attaching a hanging clip, such as the one illustrated in FIG. 10. Holes 35 are used to secure a panel to an adjacent panel.

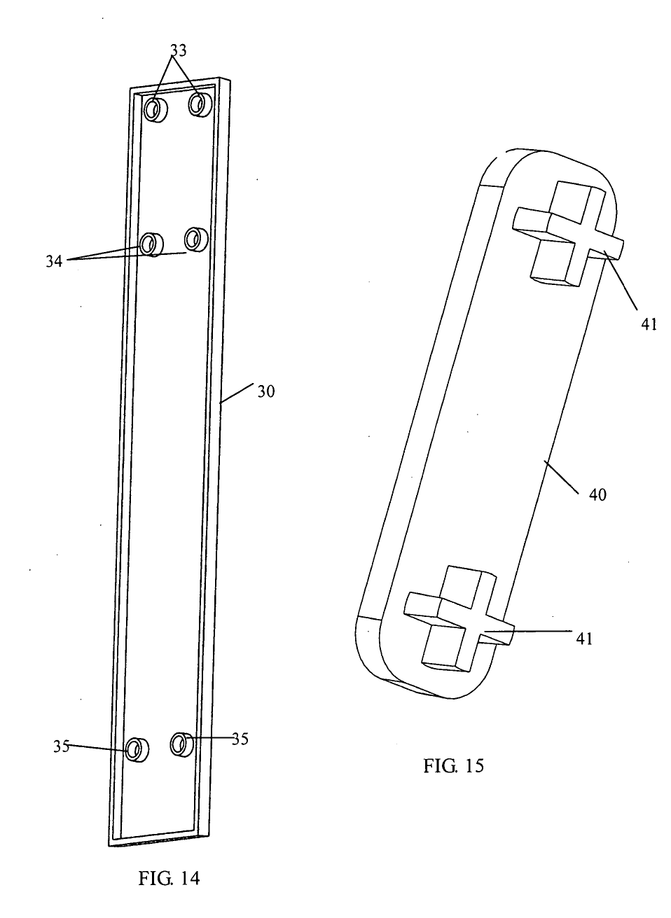

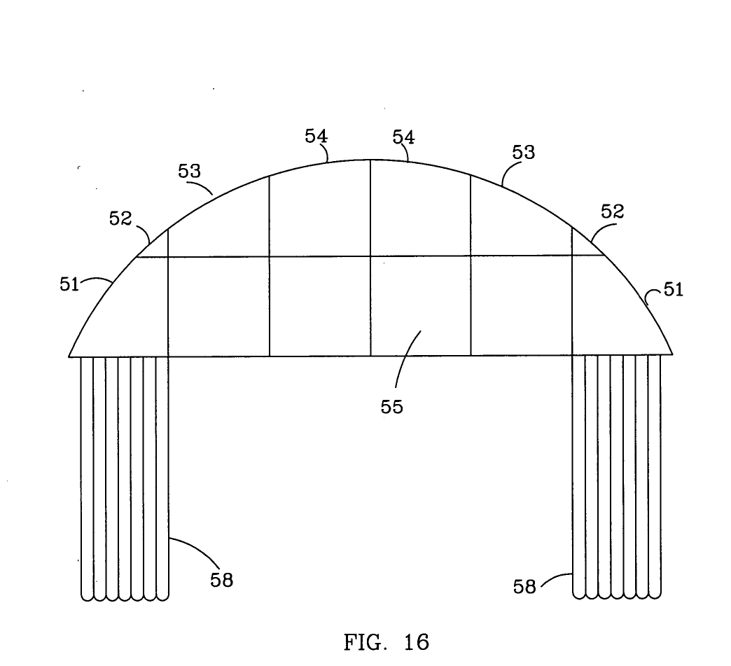

FIG. 14 is an isometric view of a small panel 30 showing the holes 33 and 34 into which the cross-shaped tapered end pins (pins 21, FIG. 10) may be inserted. The holes 35 are used for the attachment device 40 illustrated in FIG. 15. Attachment device 40 is used to secure the bottom ends of adjacent panels together by inserting one of the cross-shaped taped end pin 41 into an opening 35 in each of the adjacent panels.

FIG. 15 shows a modular cornice that may be used with an arched or circular top window. A plurality of square or rectangular panels are used with a series of panels with curved edges, such as the panels 51, 52, 53, and 54. Standard panels with curved edges are used utilizing curved edges, when joined as illustrated would form an arched or circular top edge of the modular cornice. To provide for various widths of windows, the square panels 53 mare be increased or decreased to provide the desired width of the modular cornice.

1. A modular cornice panel for attaching to a curtain rod and other wall attachment device, comprising:
a plurality of modular panels having front, back and edge sides;
at least one flexible clip device secured to each modular panel for attaching the modular panel to a wall fixture;
an opening in at least one of an edge or back of the modular panel for securing adjacent panels together.

2. The modular cornice panel according to claim 1, wherein each modular panel has a plurality of openings in the back side of the panel for attaching a device for securing the panel to a wall fixture and for securing adjacent panels together.

3. The modular cornice panel according to claim 2, wherein one opening in the back side of each panel is for attaching one end of a securing device for securing adjacent panels together.

4. The modular cornice panel according to claim 1, including a plurality of modular panels with at least one curved edge for assembling a modular cornice with a curved side.

5. The modular cornice panel according to claim 1, wherein the mounting clip is an integral part of the modular panel.

6. The modular cornice panel according to claim 1, wherein the mounting clip is a detachable clip.

7. The modular cornice panel according to claim 6, wherein the mounting clip has cross-shaped tapered end mounting pins.

8. A modular cornice panel for attaching to a curtain rod and other wall attachment device, comprising:
a plurality of modular panels having front, back and edge sides;
at least one flexible detachable clip device secured to each modular panel for attaching the modular panel to a wall fixture;
an opening in at least one of an edge or back of the modular panel for securing adjacent panels together.

9. The modular cornice panel according to claim 8, wherein each modular panel has a plurality of openings in the back side of the panel for attaching a device for securing the panel to a wall fixture and for securing adjacent panels together.

10. The modular cornice panel according to claim 9, wherein one opening in the back side of each panel is for attaching one end of a securing device for securing adjacent panels together.

11. The modular cornice panel according to claim 8, including a plurality of modular panels with at least one curved edge for assembling a modular cornice with a curved side.

12. The modular cornice panel according to claim 8, wherein the mounting clip is an integral part of the modular panel.

13. The modular cornice panel according to claim 8, wherein the mounting clip is a detachable clip.

14. The modular cornice panel according to claim 13, wherein the mounting clip has cross-shaped tapered end mounting pins.

15. The modular cornice panel according to claim 8, wherein the mounting clip is attached to two adjacent cornice panels to hold them together.
